(19) United States
(12) Patent Application Publication
(10) Pub. No.: US 2011/0223316 A1
(43) Pub. Date: Sep. 15, 2011

(54) USE OF FLUORESCING DYE IN PRETREATMENT TO IMPROVE APPLICATION AND RINSING PROCESS

(75) Inventors: Richard T. Moyle, Pataskala, OH (US); Mark W. Simpson, Warren, MI (US); Melinda H. Moeslein, Radnor, OH (US)

(73) Assignee: PPG INUDSTRIES OHIO, INC., Cleveland, OH (US)

(21) Appl. No.: 12/722,054

(22) Filed: Mar. 11, 2010

(51) Int. Cl. B05D 5/06; C09K 11/08; C09K 11/70

(52) U.S. Cl. 427/8; 252/301.4 R; 252/301.4 P

(57) ABSTRACT

A process for pretreating a substrate is disclosed. The process includes applying a composition comprising a fluorescing agent to treat an area of the substrate. The treated substrate area is then rinsed to remove excess composition. The rinsed substrate area is exposed to an energy source whereby the fluorescing agent exhibits a color upon exposure to the energy source to detect excess composition remaining on the rinsed substrate.

### FIELD OF THE INVENTION

The invention relates to methods and compositions directed to the application and removal of a pretreatment on a surface. More particularly, the invention relates to methods and compositions including a compound that fluoresces under an ultraviolet light for determining application and removal of a pretreatment on a surface.

### BACKGROUND INFORMATION

The use of protective coatings on metal substrates for improved corrosion resistance and paint adhesion is common. Conventional techniques for coating such substrates include techniques that involve pretreating the metal substrate with compositions that provide such properties. In the past, chromium was used as the coating for improving the corrosion resistance and paint adhesion of metals but has since been recognized as environmentally hazardous. Recent developments have led to the use of chrome-free coatings that provide the same desired properties.

While pretreatments such as these chrome-free pretreatments have been commercially successful, one of the major drawbacks is that chrome-free pretreatments leave little or no color on the metal substrate, unlike the previously used chromium compositions. Thus, the only indication to the user that the pretreatment has been applied to the metal is surface appearance characteristics, such as uniformity of wetting or verification by coating weight determination. Even at extreme deposition (i.e., high coating weight) of chrome-free pretreatments, where a slight indication of coloration may be present, the coloration is so faint that it is of no practical use. Accordingly, because chrome-free pretreatments show little or no coloration, the user can not determine if the pretreatment has been applied to the desired coverage area of the metal substrate. This could be detrimental, as failing to apply the pretreatment to a desired coverage area decreases the corrosion resistance and adhesion properties imparted to the substrate. Additionally, due to the lack of coloration of the chrome-free pretreatment, the user can not determine if the excess pretreatment has been completely removed from the substrate after rinsing. As such, any residual pretreatment remaining on the substrate may decrease the life of the protective paint coating by, for example, decreasing paint adhesion and/or corrosion resistance properties. Therefore, there is a need to find a diagnostic tool such as a composition and/or method for determining the application of a pretreatment to a desired substrate area as well as verifying the removal of the excess in the application process.

### SUMMARY OF THE INVENTION

The present invention is directed to a composition for treating a metal substrate comprising:
a pretreatment; and
a fluorescing agent,
wherein the composition does not include a polymeric resin.

The present invention is further directed to a method of pretreating a substrate comprising:

(a) applying a composition to treat an area of the substrate, wherein the composition comprises a fluorescing agent;

(b) exposing said treated substrate area to an energy source, wherein said fluorescing agent exhibits a color upon exposure to the energy source to detect treated and untreated portions on the substrate area;

(c) rinsing said treated substrate area to remove excess composition; and

(d) re-exposing said rinsed substrate area to the energy source, wherein said fluorescing agent exhibits a color upon exposure to the energy source to detect excess composition remaining on the rinsed substrate.

The present invention is further directed to a method of pretreating a substrate comprising:

(a) applying a composition to treat an area of the substrate, wherein the composition comprises a fluorescing agent;

(b) rinsing said treated substrate area to remove excess composition; and

(c) exposing said rinsed substrate area to an energy source, wherein said fluorescing agent exhibits a color upon exposure to the energy source to detect excess composition remaining on the rinsed substrate.

### DETAILED DESCRIPTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. For example, while reference is made herein to “a” pretreatment, “a” fluorescing agent, and the like, one or more of these or any other components can be used. In addition, in this application, the use of “or” means “and/or” unless specifically stated otherwise, even though “and/or” may be explicitly used in certain instances.

The composition of the invention comprises a pretreatment and a fluorescing agent in an aqueous medium. The composition is used for detecting and/or verifying the presence of the pretreatment on a substrate as well as indicating the presence of excess amounts remaining on the substrate after rinsing the treated substrate.

The term “pretreatment” refers to a material that upon contact with a substrate reacts with and chemically alters the contacted substrate surface and binds to it to form a protective layer. The pretreatment used in the invention requires a post rinse after application and typically is a spray on or immersion-based material. Further, the pretreatment used in the invention typically has a wet time, i.e. the amount of time the wet solution is present on the substrate, of at least one minute, such as two minutes. The longer wet time allows the pretreatment to react with all of the available free metal on the metal substrate, as opposed to for example, dry in place or roll on pretreatments that have relatively short wet times.

The pretreatment may be substantially or, in some cases, completely free of chromate. The term “substantially free” when used in reference to the absence of chromate in the pretreatment means that these substances are not present in the composition to such an extent that they cause a burden on the environment, such as less than 0.006 weight %. The term “completely free” when used with reference to the absence of chromate means that there is no heavy metal chromate in the pretreatment at all.

The pretreatment used in the invention may be based on acidic aqueous solutions such as metal phosphates. Metal cations may also be included in the pretreatment and may include, for example, iron, manganese, magnesium, zinc, nickel and cobalt, including mixtures thereof. Anions derived from added acids or from salts of metals such as nitrates, phosphates and sulfates may also be included in the pretreatment. The various salts and acids may be dissolved in water and have a solids content typically of 1 to 10% by weight and a pH of 1 to 6. Suitable pretreatments are colorless, such as CHEMFOS KA, commercially available by PPG Industries, Inc., which is a spray applied iron phosphate pretreatment and when applied, for example, to aluminum surfaces is colorless. In embodiments, the pretreatment does not include a polymeric resin.

The composition further includes a fluorescing agent. The fluorescing agent does not contribute to performance nor becomes an integral part of the pretreatment and is capable of exhibiting a color by fluorescing on exposure to a light energy source capable of exciting the dye, such as ultraviolet light and the like. For example, when exposed to ultraviolet light, the fluorescing agent absorbs the ultraviolet light and converts the energy taken up into longer wavelength visible portions of the spectrum as evidenced by fluorescence. Examples of sources of ultraviolet radiation include, for example, a mercury vapor lamp filtered optically such that only those emissions between 250 and 400 nanometers (nm) are incident to the area being inspected. Alternate light sources include xenon lamps and tungsten lamps. It is preferred that the energy range of the light source is coincident with one or more electronic absorption bands in the fluorescing agent, but not coincident with that of the fluorescent emissions of the fluorescing agent.

A suitable fluorescing agent is acid resistant. In embodiments, the fluorescing agent is water soluble. The fluorescing agent used in the composition may be selected from a fluorescent dye and/or an optical brightener. Classes of fluorescent dyes that may be used in the pretreatment composition of the invention include pyrannines, rhodamines, stilbenes; coumarin and carbostyril compounds; 1,3-diphenyl-2-pyrazolines; naphthalimides; benzazdyl substitution products of ethylene, phenylethylene, stilbene and thiophene and the like. Among fluorescent dyes that may be used are also the sulfonic acid salts of diamino stilbene derivatives such as taught in U.S. Pat. No. 2,784,220 to Spiegler at col. 1, line 47-col. 3, line 11, the cited portion of which being incorporated by reference herein. Optical brightness or fluorescent whitening agents as taught in U.S. Pat. No. 5,082,578 to Langer et al. at col. 3, line 55-col. 7, line 50, the cited portion of which being incorporated by reference herein, are also contemplated by this invention. Specific examples include OPTIBLANC MTB and OPTIBLANC NW (Stilbene triazine derivatives). These are available from 3V Sigma, S.p.A. of Bergamo, Italy. Suitable fluorescent dyes include but are not limited to D96183 CHROMATINT Pyranine LIQ. 1568 and D23041 CHROMATINT Rhodamine B Liquid, both supplied by Chromatech, Inc.

The amount of fluorescing agent in the composition may vary and is used in an amount sufficient to impart at least some level of florescence upon treatment of the substrate. The fluorescing agent may be premixed with the pretreatment or alternatively, may be mixed with the pretreatment at a work site prior to use. The fluorescing agent may be present in the composition in an amount of at least 20 parts per million. For example, the fluorescing agent may be present in an amount of at least 0.025% by weight based on total composition weight or at least 10 parts per million when the composition is diluted with water at a work site.

In embodiments, the composition includes at least 0.5% by weight, such as 1.0% by weight of the fluorescing agent based on the total weight of the composition. In other embodiments, the amount of fluorescing dyes may include 2% by weight of the fluorescing agent based on the total weight of the composition.

Embodiments of the present invention are directed to pretreating a metal substrate. Suitable metal substrates for use in the present invention include those that are often used in the assembly of automotive bodies, automotive parts, and other articles, such as small metal parts, including fasteners, i.e., nuts, bolts, screws, pins, nails, clips, buttons, and the like. Specific examples of suitable metal substrates include, but are not limited to, ferrous metals, cold rolled steel, hot rolled steel, steel coated with zinc metal, zinc compounds, or zinc alloys, such as electrogalvanized steel, hot-dipped galvanized steel, galvannealed steel, and steel plated with zinc alloy. Also, aluminum alloys, aluminum plated steel and aluminum alloy plated steel substrates may be used. Other suitable non-ferrous metals include copper and magnesium, as well as alloys of these materials. Moreover, the metal substrate being coating may be a cut edge of a substrate that is otherwise treated and/or coated over the rest of its surface or alternatively, may be in the form of, for example, a sheet of metal or a fabricated part.

The method of the invention comprises applying the composition described herein on the metal substrate. Prior to application of the composition, the metal substrate to be treated may be cleaned to remove grease, dirt, or other extraneous matter. This may be done by employing mild or strong alkaline cleaners, or cleaning solvents and the like, such as are commercially available and used in metal pretreatment processes. Examples of alkaline cleaners suitable for use in the present invention include Chemkleen 163, Chemkleen 177, and Chemkleen 490MX, each of which are commercially available from PPG Industries, Inc. Examples of cleaning solvents suitable for use in the present invention include silane, isopropyl alcohol, naphthalene and the like including mixtures thereof. Such cleaners and/or cleaning solvents are often followed and/or preceded by a water rinse.

The composition may then be applied on or brought into contact with the substrate by any of a variety of known techniques, such as dipping or immersion, spraying, intermittent spraying, dipping followed by spraying or spraying followed by dipping. The composition may be applied to a portion or a desired area of the substrate or in embodiments, may be applied to the entire surface area of the substrate. “Desired area” or “area” of a substrate as used herein refers to at least a portion of the substrate.

In certain embodiments, the composition when applied to the metal substrate is typically at a temperature ranging from 60 to 150° F. (15 to 65° C.). The contact time may be from 10 seconds to five minutes, such as 30 seconds to 2 minutes. In embodiments, the composition having the pretreatment of CHEMFOS KA for example, is applied at a temperature of 110° F. (43° C.) or less. While not being limited to any theory, the inventors have unexpectedly found that applying the composition with a temperature greater than 110° F. decreases the stability of the composition. For example, the fluorescing agent congeals in solution turning into solid and then precipitates out as the temperature is increased, thereby decreasing the stability of the composition.

The thickness of the composition when applied to the substrate may vary, but is typically thin, having a thickness of less than 1 micrometer, such as from 1 to 500 nanometers, and 10 to 300 nanometers.

After application of the composition to the metal substrate, the coated metal substrate is exposed to any light energy source capable of exciting the dye. In an embodiment, the light energy source is as an ultraviolet light. Upon exposure to the ultraviolet light, the fluorescing agent in the pretreatment fluoresces, thereby allowing for visual observation to determine if the desired substrate area has been treated or coated with the pretreatment. As used herein, “treated” refers to the portion of the substrate to which the composition has been applied. Any areas that do not exhibit fluorescence in the desired substrate area to be treated indicate to the user that the pretreatment has not been applied to the entire desired substrate area. Therefore, the presence of the fluorescing agent in the composition allows for visual observation and/or detection of the presence of the composition on the substrate. After exposing the treated substrate to ultraviolet light, the user may apply the composition to the substrate areas that did not exhibit fluorescence, or alternatively, may reapply the composition to the entire substrate area. In embodiments, the user may perform the steps of applying the composition and exposing the treated substrate repeatedly until the user is satisfied that the pretreatment has been applied to the entire desired substrate area.

Upon verification that the pretreatment has been applied to the desired substrate area, the excess composition is rinsed from the substrate. The rinse step is performed, for example, to keep the excess composition from standing or puddling on the treated metal substrate. The process of rinsing can be performed in any manner as appreciated by one skilled in the art. In embodiments, the material to rinse the substrate may comprise an aqueous material, such as water. In other embodiments, the rinse comprises a water-based sealer, such as a zirconium or silane treatment. A suitable sealer is CHEMSEAL 59, commercially available from PPG Industries, Inc. During rinsing, the sealer removes the excess composition including the fluorescing agent as well as acts as a protective seal or layer on the surface of the treated substrate.

After rinsing the treated substrate, the substrate is exposed to ultraviolet light to verify that the excess composition has been completely removed from the treated substrate area. Any fluorescence observed on the substrate by the user indicates the presence of residual excess composition remaining on the substrate or in the case of the sealer coat, an area that was not sealed. The user may then perform a subsequent rinse step to remove the remaining excess composition. In embodiments in the subsequent rinse, portions of the treated substrate exhibiting fluorescence may be rinsed, or alternatively, the entire treated substrate area may be rinsed. The subsequently rinsed substrate may again be exposed to ultraviolet light to verify that that the remaining excess composition has been removed.

In embodiments, the method of the invention comprises applying a composition of the invention to treat the substrate. The treated substrate area is then rinsed to remove excess composition and the rinsed substrate area is then exposed to an ultraviolet light. Upon exposure to the ultraviolet light, the fluorescing agent in the composition exhibits a fluorescence or color. The fluorescence or color indicates to the user that excess composition is still present on the rinsed substrate and that, for example, the treated substrate has not been thoroughly rinsed. If excess composition is detected on the substrate, the user may repeat the steps of rinsing the substrate and/or re-exposing the rinsed substrate to an ultraviolet light to detect excess composition remaining on the substrate until the user is satisfied that all of the excess composition has been removed from the treated substrate area. This method may be used, for example, with an iron phosphate pretreatment and a ferrous substrate, whereby as a result of the pretreatment reacting with the substrate, some coloration is visible upon observation without the use of a fluorescent dye.

In embodiments, after the excess composition is removed from the substrate by any of the methods described herein, a coating composition may be applied on the surface thereon comprising a film-forming resin such as those used in automotive OEM coating compositions, automotive refinish coating compositions, industrial coating compositions, architectural coating compositions, coil coating compositions, and aerospace coating compositions, among others. Any suitable technique may be used to apply the coating composition including, for example, brushing, dipping, flow coating, spraying and the like.

The method of the invention can be used for applications such as pretreating fuel tanks, aircraft fueling vehicles and the like. In other embodiments, the method can be used in processes where a user may want to verify or confirm application of any coating, as well as the removal of excess coating. The method described herein is not limited to the use of a pretreatment composition and can be used with any composition that includes a fluorescing agent.

Whereas, particular embodiments of this invention have been described above for purposes of illustration, it will be evident to those skilled in the art that numerous variations of the details of the present invention may be made without departing from the invention as defined in the appended claims.

What is claimed is:

1. A composition for treating a metal substrate comprising:
a pretreatment; and
a fluorescing agent;
wherein the composition does not include a polymeric resin.

2. The composition of claim 1, wherein the pretreatment is substantially or completely chrome-free.

3. The composition of claim 1, wherein the pretreatment comprises metal phosphates.

4. The composition of claim 1, wherein the fluorescing agent is acid resistant and water soluble.

5. The composition of claim 1, wherein the composition comprises at least 0.5% by weight of the fluorescing agent based on the total weight of the composition.

6. A method of pretreating a substrate comprising:
(a) applying a composition to treat an area of the substrate, wherein the composition comprises a fluorescing agent;
(b) exposing said treated substrate area to an energy source, wherein said fluorescing agent exhibits a color upon exposure to the energy source to detect treated and untreated portions on the substrate area;
(c) rinsing said treated substrate area to remove excess composition; and
(d) re-exposing said rinsed substrate area to the energy source, wherein said fluorescing agent exhibits a color upon exposure to the energy source to detect excess composition remaining on the rinsed substrate.

7. The method of claim 6, further comprising reapplying the composition prior to step (c), wherein the step of reapplying comprises applying the composition to at least the untreated portion on the substrate area.

8. The method of claim 7, further comprising exposing at least the untreated portion on the substrate area to the energy source to verify the presence of the composition on the substrate area.

9. The method of claim 6, further comprising a subsequent rinsing step after step (d), wherein the subsequent rinsing step comprises rinsing at least the excess composition on the substrate area.

10. The method of claim 9, further comprising exposing at least the subsequently rinsed substrate area to the energy source to verify removal of the excess composition on the substrate area.

11. The method of claim 6, wherein the energy source comprises an ultraviolet light.

12. The method of claim 6, wherein the substrate area comprises at least a portion of the substrate.

13. The method of claim 6, wherein the composition comprises a pretreatment comprising metal phosphates.

14. The method of claim 6, wherein step (c) is performed with water or a sealer.

15. The method of claim 6, wherein the fluorescing agent is acid resistant and water soluble.

16. The method of claim 6, wherein the composition comprises at least 0.5% by weight of the fluorescing agent based on the total weight of the composition.

17. The method of claim 6, wherein the composition in step (a) has a temperature of 43° C. or less.

18. A method of pretreating a substrate comprising:
(a) applying a composition to treat an area of the substrate, wherein the composition comprises a fluorescing agent;
(b) rinsing said treated substrate area to remove excess composition; and
(c) exposing said rinsed substrate area to an energy source, wherein said fluorescing agent exhibits a color upon exposure to the energy source to detect excess composition remaining on the rinsed substrate.

19. The method of claim 18, further comprising a subsequent rinsing step after step (c), wherein the subsequent rinsing step comprises rinsing at least the excess composition on the substrate area.

20. The method of claim 19, further comprising exposing at least the subsequently rinsed substrate area to the energy source to verify removal of the excess composition on the substrate area.
